(19) United States
(12) Patent Application Publication
(10) Pub. No.: US 2012/0217296 A1
(43) Pub. Date: Aug. 30, 2012

(54) Reversing 2D barcode scanning for real-time social networking

(76) Inventor: David Merel, New York, NY (US)

(21) Appl. No.: 13/036,004

(22) Filed: Feb. 27, 2011

(51) Int. Cl. G06K 5/00

(52) U.S. Cl. 235/380

(57) ABSTRACT

A process for streamlining social networking in real-time as well as the process of generating and submitting social network information on behalf of the user. The process reverses the traditional method of 2D barcodes in their relation to social networking. The user presents a 2D barcode which securely references their social network information and the processes social network. This process reduces social networking operations on behalf of a user to a few seconds. Reversing the 2D barcode process to having the merchant being responsible for the decoding instead of user additionally removes technical requirements on behalf of the user such as the need of having a smartphone or internet data plan.

### BACKGROUND OF THE INVENTION

1. Field of the Invention

The present invention generally relates to data processing, and more particularly, to a method and system for streamlining social networking in real-time as well as the process of generating and submitting social network information on behalf of the user.

2. Description of the Related Art

2D barcodes such as QR have become popular tools to allows users to quickly retrieve information on a product or service. A 2D barcode such as QR is a consists of black modules arranged in a square pattern on a white background. The information encoded can be text, URL or other data. Using 2D barcodes have become useful in leveraging social networking for marketing purposes. An electronic social network is able to maintain a list of related individuals for a member. Since an electronic social network stores a relationship (or link) to a related individual from a member, data added by a member is communicated to others individuals related to the member.

Typically the relationship between the above technologies involved the social network member to have a smartphone with an internet connection as well as a built in camera. The merchant would place the 2D barcode on a product or signage and the social network member would use an electronic application on the smartphone to decode the 2D barcode. The decoded information would typically contain a URL or some other form of text. The member would then transmit the decoded information to their social network.

This process requires the member to have a smartphone, a built in camera, an internet connection as well as good signal strength. Additionally the process can be quite lengthy for capturing and submitting the data to the member's social network. There is a need to remove the technical requirements listed above from the member as well as a process to dramatically reduce the length of time to transmit social network information.

This invention addresses the above shortcomings by reversing the process of how social networking data is retrieved and transmitted. Instead of the member retrieving the information they instead transmit the information. By reversing this process the invention removes the member's requirement to have a smartphone and internet connection and since the mechanism for decoding and transmitting is accomplished by the merchant the length of time is reduced to seconds requiring the user to only present their 2D barcode to the merchant's scanner.

When transmitting social network information one of the biggest concerns is keeping user information secure. Typically the transmission of social network information would involve at minimum an encryption of the users social network information stored within the barcode. There several shortcomings using such as process. First, 2D barcodes can only contain a limited amount of data; therefore a user with a large quantity of subscriptions to various social networks may not be able to fit their encrypted information onto a single barcode. Second, encrypting a user's social network information onto a barcode is inefficient since every time a user changes their authentication information a new barcode would need to be generated. Third, this process poses a security risk where if someone manages to decode a stolen barcode a hacker would have full access to the user's social network authentication information. Our second claim rectifies all of the above shortcomings by encrypting the barcode with user specific data like a username or email address belonging to an account on a central server. Therefore, the barcode contains only encrypted information related to the parent hosting account and none of the social network authentication information. Additionally there is no need to ever re-generate a barcode since the barcode references the parent account which in turn references the social networks via a central database. Since all social network authentication information are relayed via a proxy database there is no space limitations in the barcode since only a single parent account identifier is needed. In regards to security, even if the barcode was decoded by a hacker, the only information which will be made available is a single identifier used by the parent account; this information cannot be used to obtain any of the user's social network authentication information.

### SUMMARY OF THE INVENTION

The invention provides a technique to streamline social networking in real-time and remove the necessity of a smartphone or data connection on behalf of the user. Traditionally 2D barcode scanning in regards to social networking is accomplished with the user performing the scan of the 2D barcode and is also responsible for the transmission of the decoded information back to the social network. Our invention reverses this process eliminating dependency of a smartphone and data connection. The 2D barcode is encrypted with a username provided by a remote database which in turn contains encrypted data pertaining to the users social network authentication information. A merchant, retailer, exhibitor or advertiser can scan the user's 2D barcode and transmit the information to a remote database which in turns submits social networking actions on behalf of the user. This process removes any internet/cellular service plan or smartphone requirement on behalf of the user since a 2D barcode can be used on any standard phone as well as being printed on paper. The responsibility of a data connection is removed from the user and instead the processed by the merchant. The process additionally reduces the length of time to several seconds since the user simply needs to display their 2D barcode.

Additionally the invention incorporates a streamlined and enhancement for loyalty card programs. The invention incorporates social networking with each reward point earned by the shopper. As in the same process mentioned above a merchant can scan a shoppers 2D barcode which will register points on the shoppers loyalty card program but additionally each scan will communicate the merchants products or services to that users social network. Additionally this process can instantly enroll users into a merchant's loyalty card program. Each scan will both register points and conduct real-time social networking on behalf of the merchant. Once a specified amount of points are earned on behalf of the shopper an electronic transmission via MMS, SMS or Email is transmitted to the shopper for redemption. Additionally the redemption of the reward is coupled with additional marketing to the shopper's social network.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a flowchart diagram of an embodiment of the present invention pertaining to the reversed 2D barcode process

FIG. 2 is a block diagram of an embodiment of the present invention detailing the enhanced security and encryption process of the 2D barcode in relation to the social networks.

### DETAILED DESCRIPTION OF THE DRAWINGS

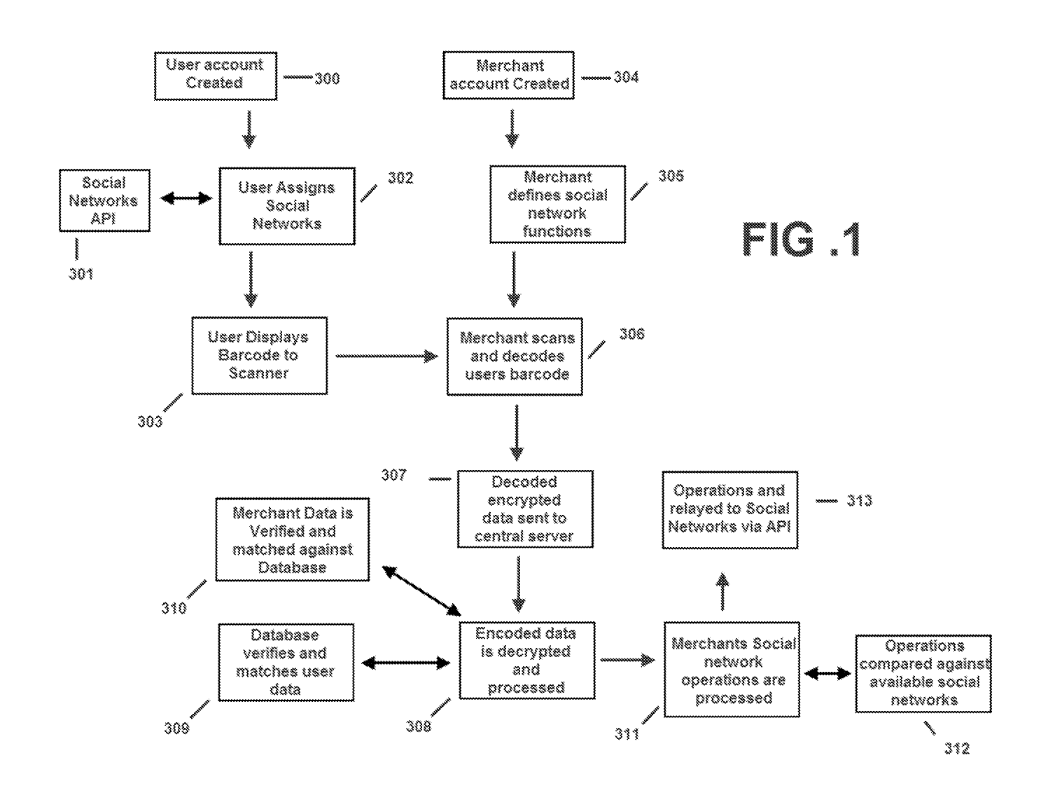

In FIG. 1, step 300 the process starts with a user creating their social network 2D barcode via a web based interface. Once the users account is created the user assigns their social networks to their account 302. Each social network is integrated into the users account by the system requesting an authentication token provided by the users social network's API 301. The user presents their 2D barcode in front of a scanner such as a webcam or any other optical device enabling the recognition and decoding of a 2D barcode 303. The merchant, before setting up their scanner, had earlier setup their account via a remote web based interface 304. The merchant specifies a social networking action to occur when a barcode is scanned 305. When the barcode is scanned on behalf of the merchant it is decoded instantly on the merchant side and the encrypted decoded information 306 is transmitted to a central server where the encrypted identifier decoded by the merchant's scanner is processed 307. The remote central database decrypts the identifier 308 and matches it against a database containing users 309. Additionally along with the encrypted identifier the merchant also transmits the merchant username and password. If a match exists between the decrypted identifier and the user table, it then proceeds to authenticate the merchant information which was also transmitted 310. If a match exists against the merchant user table in the central database 311, the system then takes the social network operations specified by the merchant and compares them to the available social networks belonging to the user 312. For each match shifts exists the social network operation and information defined by the merchant is relayed to the user's social network's API 313. The central database using the token provided by the social network can now transmit and post information to the users social networks.

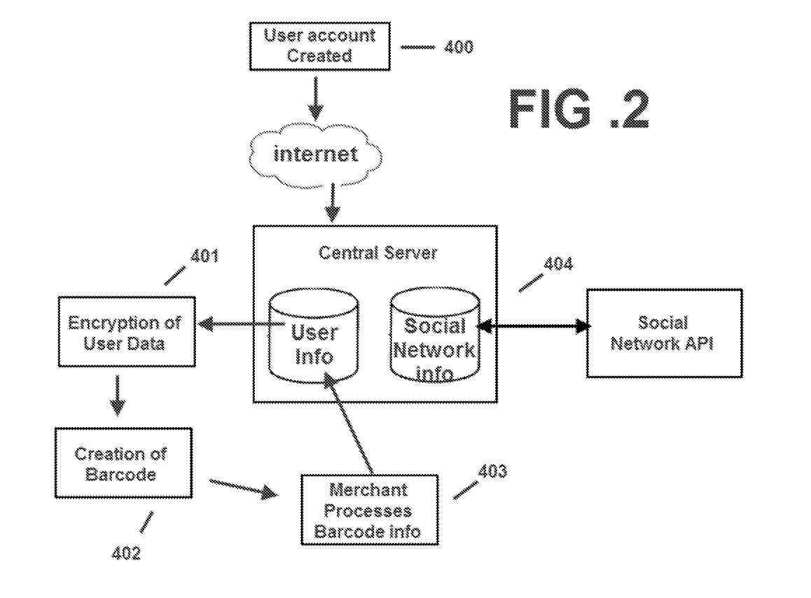

FIG. 2 represents the process taken to enhance security during the transmission of the user's social network information. When an account is created by the user on the central database 400, the piece of data representing only information pertaining to the created account such as username or email address is encrypted 401 and then placed immediately into a 2D barcode 402. Any changes to the users account such as addition, modification or removal of social network information has no bearing on the 2D barcode. When the 2D barcode information is scanned and decoded by the merchant 403 the only information made available to the merchant is an encrypted string of data relevant only to the central server's local user information, not any of the social networking information 404. This process allows for even further security since even if decrypted the information only contains local user information but none of the social network information obtained by the social network's API. This process deploys a unique double layer of protecting the users social network information in barcode transmission.

The invention claimed is:

1. A computer-implemented method comprising: creating a 2D barcode which contains an individual shoppers/visitors encrypted identifier marker which in turn relates to their social network authentication information stored on a database storage device coupled to a server. A party such as a merchant responsible for scanning the 2D barcode information specifies marketing information on a database storage device which in turn is to be communicated to a member social network upon completion of a scan. The 2D barcode information in the form of a digital image or paper is scanned using an optical device such as a webcam or barcode scanner and is transmitted via the internet to a database storage device coupled to a server hosting the member's social network information. The database in turn relays the scanning party's information to the member's social networks.

2. The method of claim 1, wherein the process of further enhancing the barcode security by placing an encrypted marker which in turn links to an encrypted token provided by the members social network. This process removes any of the users social network authentication information from being transmitted.
